(19) United States
(12) Patent Application Publication
(10) Pub. No.: US 2014/0122558 A1
(43) Pub. Date: May 1, 2014

(54) TECHNIQUE FOR OFFLOADING COMPUTE OPERATIONS UTILIZING A LOW-LATENCY DATA TRANSMISSION PROTOCOL

(71) Applicant: NVIDIA CORPORATION, Santa Clara, CA (US)

(72) Inventor: Hassane S. AZAR, Los Altos, CA (US)

(73) Assignee: NVIDIA CORPORATION, Santa Clara, CA (US)

(21) Appl. No.: 13/663,434

(22) Filed: Oct. 29, 2012

(51) Int. Cl. H04W 8/00; G06F 15/16

(52) U.S. Cl. 709/201

(57) ABSTRACT

Embodiments of the invention provide techniques for offloading certain classes of compute operations from battery-powered handheld devices operating in a wireless private area network (WPAN) to devices with relatively greater computing capabilities operating in the WPAN that are not power-limited by batteries. In order to offload certain classes of compute operations, a handheld device may discover an offload device within a local network via a discovery mechanism, and offload large or complex compute operations to the offload device by utilizing one or more low-latency communications protocols, such as Wi-Fi Direct or a combination of Wi-Fi Direct and real-time transport protocol (RTP). One advantage of the disclosed techniques is that the techniques allow handheld devices to perform complex operations without substantially impacting battery life.

### BACKGROUND OF THE INVENTION

1. Field of the Invention

The present invention relates generally to computing systems and, more specifically, to a technique for offloading compute operations utilizing a low-latency data transmission protocol.

2. Description of the Related Art

Low power design for many consumer electronic products has become increasingly important in recent years. With the proliferation of battery-powered handheld devices, efficient power management is quite important to the success of a particular product or system. Among other things, users of handheld devices are demanding the ability to perform tasks on their device that may require the processing of large or complex compute operations. Examples of such tasks include auto-fix of captured video, stereoscopic image and video processing, computer vision, and computational photography. However, the demand for performing such tasks on a handheld device comes at the cost of reduced battery life.

Specifically, irrespective of the techniques that have been developed to increase performance on handheld devices, such as multi-threading techniques and multi-core techniques, too much power may be consumed by these devices when performing such computationally expensive tasks, which can lead to poor user experiences. Therefore, although a handheld device may have the processing power to perform those types of tasks, it may not be desirable for the handheld device to perform such tasks because of the negative impact on battery life. In fact, many handheld devices are simply not configured with sufficient processing power to perform complex processing tasks like those described above, because, as is well-understood, including such processing power in handheld devices would come at the cost of accelerated battery drain.

As the foregoing illustrates, what is needed in the art is a technique that allows handheld devices to perform compute operations that are more complex without substantially impacting battery life.

### SUMMARY OF THE INVENTION

One embodiment of the present invention sets forth a method for offloading one or more compute operations to an offload device. The method includes the steps of discovering the offload device in a wireless private area network (WPAN) via a low-latency communications protocol, offloading data to the offload device for performing the one or more compute operations, and receiving from the offload device processed data generated when the one or more compute operations are performed on the offloaded data.

One advantage of the disclosed method is that a handheld device may perform complex operations without substantially impacting battery life. Another advantage of the disclosed method is that a handheld device has more flexibility in terms of the types of applications that can be installed or downloaded and executed using the handheld device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 provides an illustration of a wireless private area network (WPAN), according to one embodiment of the present invention.

FIG. 2 is a conceptual illustration of the communications between one of the handheld devices and one of the offload devices within the WPAN of FIG. 1, according to one embodiment of the present invention.

FIG. 3 illustrates a technique for offloading compute operations from a handheld device to an offload device with relatively greater computing capabilities, according to one embodiment of the present invention.

FIG. 4 is a flow diagram of method steps for offloading compute operations from a handheld device to an offload device having relatively greater computing capabilities, according to one embodiment of the present invention.

FIG. 5 provides an illustration of a conventional WPAN configured to implement one or more aspects of the present invention.

FIG. 6A provides an illustration of a handheld device that is utilized for gesture recognition, according to one embodiment of the present invention.

FIG. 6B provides an illustration for offloading compute operations from a handheld device to an offload device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

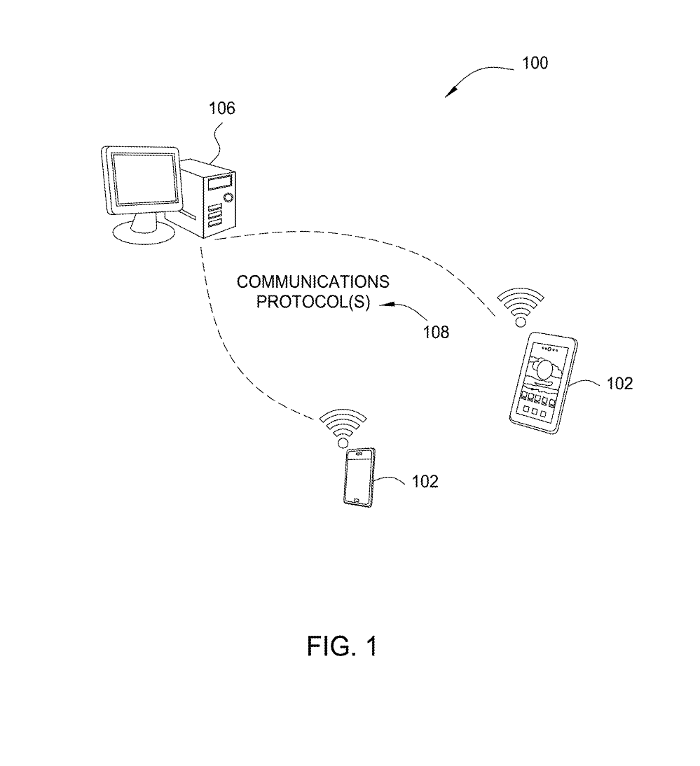

FIG. 1 provides an illustration of a wireless private area network (WPAN) 100, according to one embodiment of the present invention. As shown, the WPAN 100 includes, without limitation, one or more battery-powered handheld devices 102 and a wall-powered “offload” device 106. Examples of handheld devices 102 generally include, without limitation, cellular phones, smart phones, personal digital assistants, and tablet devices. In addition, the WPAN 100 may include other media devices, such as televisions, although not illustrated. The wall-powered offload device 106 has relatively greater computing capabilities than the different handheld devices 102. In various embodiments, for example, the offload device 106 may be, without limitation, a machine that has one or more graphics processing units (GPUs) or one or more GPUs that are configurable to implement Compute Unified Device Architecture (CUDA) capabilities, such as a desktop, a server machine. In other embodiments, the offload device may be another handheld device that has higher computing capabilities and is plugged into an alternating-current power source and, thus, not power-limited like handheld devices 102. Within the WPAN 100, the different handheld devices 102 communicate directly with the offload device 106 using a low-latency communications protocol 108, such as Wi-Fi Direct. In various embodiments, WPAN 100 may include any number of handheld devices 102 and any number of offload devices 106.

Wi-Fi Direct is a standard that allows Wi-Fi devices to connect and communicate with each other without the need for a wireless access point. Therefore, handheld devices 102 and device 106 may communicate directly, or peer-to-peer (P2P), through the Wi-Fi Direct protocol. In one embodiment, WPAN 100 is configured such that the handheld devices 102 may offload certain classes of compute operations to the offload device 106 by utilizing Wi-Fi Direct. Examples of tasks involving such compute operations include auto-fix of captured video, stereoscopic image and video processing, computer vision, and computational photography. Compared to devices communicating in a WPAN via a wireless access point, Wi-Fi Direct provides higher throughput for devices within close range, allowing for the transmission of greater amounts of data. In addition, with the ability to communicate directly between a handheld device 102 and the offload device 106, the amount of time required to offload a compute operation from the handheld device 102 to the offload device 106 and receive the processed results back from the offload device 106 may be within the processing times tolerated by many applications. Therefore, a handheld device 102 may offload compute operations suited for real-time computing offload scenarios, such as real-time processing of photos and videos captured using handheld device 102.

Although Wi-Fi Direct has been illustrated as an appropriate protocol for exchanging communications between the handheld devices 102 and the offload device 106, any protocol that encourages low-latency data transmissions may be utilized. In addition, a combination of low-latency communications protocols may be used for exchanging data and information between the handheld devices 102 and the offload device 106. For example, real-time transport protocol (RTP) may be used in conjunction with Wi-Fi Direct for streaming data between a handheld device 102 and the offload device 106. Using RTP in conjunction with Wi-Fi Direct may be used in situations where the compute operations involve the processing of video or audio data (e.g., the data and the resulting processed data would be streamed).

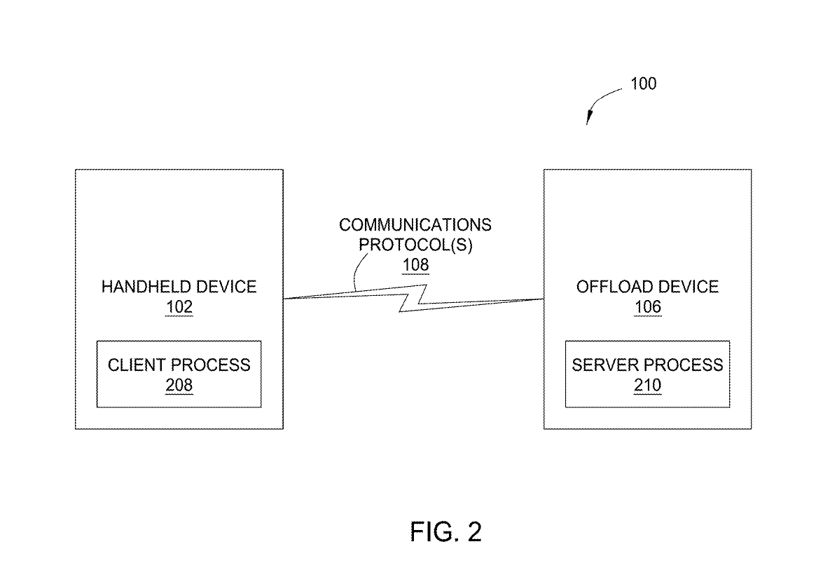

FIG. 2 is a conceptual illustration of the communications between one of the handheld devices 102 and one of the offload devices 106 within the WPAN 100 of FIG. 1, according to one embodiment of the present invention. As shown, the handheld device 102 communicates with the offload device 106 via one or more low-latency communications protocols 108, such as Wi-Fi Direct or a combination of Wi-Fi Direct and RTP. As described above, low-latency communications protocol, such as Wi-Fi Direct, give handheld device 102 the ability to offload compute operations to an offload device 106 and receive the processed results back from the offload device 106 within the processing times tolerated by many compute applications that may execute on handheld device 102. Therefore, the handheld device 102 may offload compute operations suited for real-time computing offload scenarios, thereby circumventing the need for the handheld device to perform those compute operations directly. Consequently, the handheld device 102 does not have to expend battery power performing such operations, which typically are computationally intensive operations that would quickly drain the batteries powering the handheld device 102.

As also shown, and as will be described in greater detail herein, the handheld device 102 includes a client process 208 that communicates with a server process 210 via the communications protocol 108 when offloading compute operations from the handheld device 102 to the offload device 106. In operation, to offload an operation to the offload device 106, the client process 208 may discover the offload device 106 within the WPAN via a discovery mechanism. For example, the handheld device 102 and the offload device 106 may negotiate a link by using Wi-Fi Protected Setup. Once the offload device 106 is discovered, the client process 208 may offload large or complex compute operations to the offload device 106. Prior to offloading the compute operations from the handheld device 102, the client process 208 may perform certain operations such as encoding data for the compute operations that are being offloaded. Optionally, the client process 208 may also encrypt the encoded data in an effort to secure the data prior to offloading the compute operations over the wireless link. The server process 210 may perform the compute operations offloaded from the handheld device 102 to the offload device 106. Prior to performing the compute operations, the server process 210 may decrypt the data for the compute operations (i.e., if the data was encrypted). In addition, the server process 210 may decode the data and then perform the compute operations. Upon performing the compute operations, the server process 210 may transmit the processed results to the handheld device 102.

As an example for offloading certain classes of compute operations from the handheld device 102 to the offload device 106, the offload device 106 may advertise specific services that the handheld device 102 may need, such as support for gesture recognition or facial recognition tasks. If the handheld device 102 is then utilized for a gesture recognition or facial recognition task, the handheld device 102 may offload data collected by the handheld device 102, such as one or more captured-images, to the offload device 106 that has advertised those specific services. In other words, the processing related to the gesture recognition or facial recognition task occurs at the offload device 106, and the offload device 106 then transmits the processed results back to the handheld device 102.

In another contemplated implementation, rather than advertising specific services that the handheld device 102 may utilize, the offload device 106 may advertise its compute capabilities to the handheld device 102. The handheld device 102 can then leverage those compute capabilities on an as-needed basis, such as when executing a more sophisticated computer program. For example, in addition to offloading captured images for gesture recognition or facial recognition task from the handheld device 102 to the offload device 106, the handheld device 102 may also offload the program code for performing the gesture recognition or facial recognition task to the offload device 106. As a result, the offload device 106 is able to perform the gesture recognition or facial recognition task using the data and program code received from the handheld device 102 and then transmit the processed results back to the handheld device 102. With the ability to offload program code to the offload device 106, there is more flexibility in terms of the types of applications that can be installed or downloaded on the handheld device 102 because the handheld device 102 can offload the work related to those applications to an offload device 106 that advertises its compute capabilities to the handheld device 102.

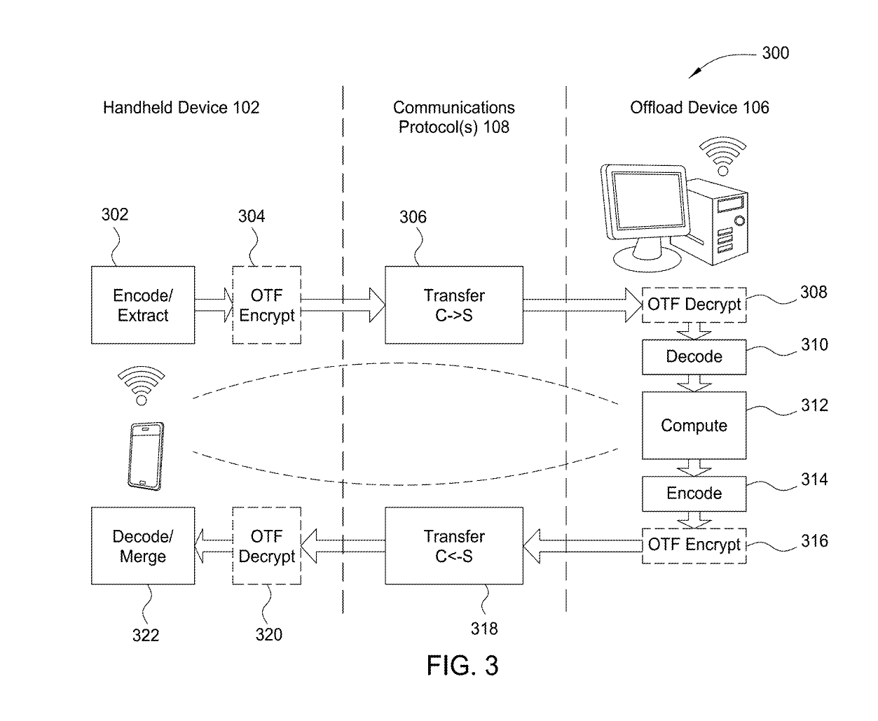

FIG. 3 illustrates a technique 300 for offloading compute operations from a handheld device 102 to an offload device 106 with relatively greater computing capabilities, according to one embodiment of the present invention. At 302, prior to transmitting the data for the compute operations that are being offloaded, the handheld device 102 encodes the data. Optionally, at 304, the data may be encrypted on the fly (OTF). However, encrypting the data may introduce latencies for the time spent encrypting and decrypting the data. At 306, the encoded data is transmitted from the handheld device 102 to the offload device 106 via the low-latency communications protocol 108. If the data is encrypted prior to being offloaded from the handheld device 102, the encoded data is decrypted by the offload device 106 at 308 and then decoded at 310.

At 312, the offload device 106, which may include one or more GPUs, performs one or more compute operations using the data offloaded from the handheld device 102. If program code is also offloaded from the handheld device 102, then the offload device 106 performs the compute operations based on the offloaded program code. After performing the compute operations, the offload device 106 encodes the processed results at 314 and optionally encrypts the results at 316, prior to transmitting the results back to the handheld device 102 at 318. Upon receiving the processed results, the handheld device 102, to the extent necessary, decrypts the processed results at 320 and decode the processed results at 322.

As the foregoing illustrates, by using one or more low-latency communications protocols, such as Wi-Fi Direct or a combination of Wi-Fi Direct and RTP, the handheld device 102 may offload compute operations to the offload device 106 and receive the processed results back from the offload device 106 within the processing times tolerated by many applications that may execute on the handheld device 102. In other words, the handheld device 102 may offload compute operations suited for real-time computing offload scenarios, thereby circumventing the need for the handheld device to perform those compute operations directly. Consequently, the handheld device 102 does not have to expend battery power performing such operations, which typically are computationally intensive operations that would quickly drain the batteries powering the handheld device 102.

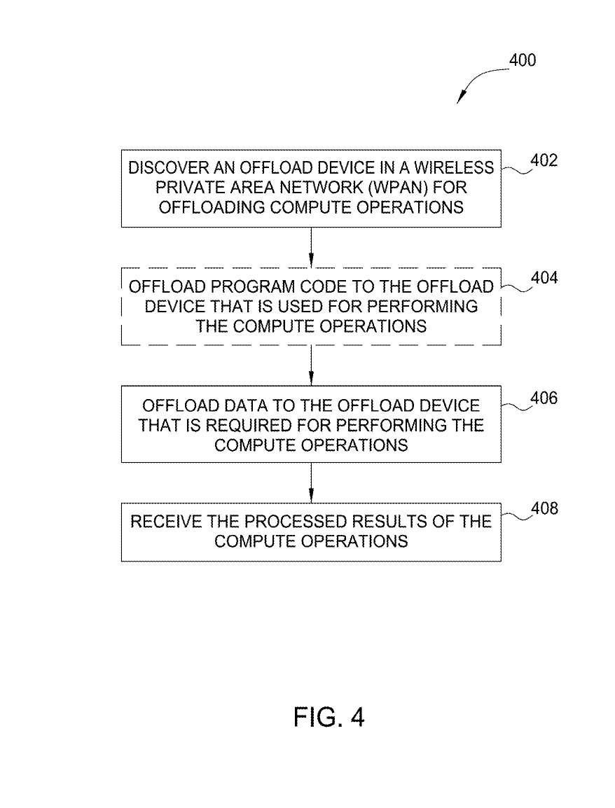

FIG. 4 is a flow diagram 400 of method steps for offloading compute operations from a handheld device 102 to an offload device 106 having relatively greater computing capabilities, according to one embodiment of the present invention. Although the method steps are described in conjunction with FIGS. 1-3, persons skilled in the art will understand that any system configured to perform the method steps, in any order, falls within the scope of the present invention.

As shown, the method begins at step 402, where the handheld device 102 discovers the offload device 106 in a WPAN 100 for offloading compute operations (e.g., via a discovery mechanism). As an example, the handheld device 102 may negotiate a link with the offload device 106 by using Wi-Fi Protected Setup.

Optionally, at step 404, the handheld device 102 may offload program code to the offload device 106 that is used for performing the compute operations. For example, the offload device 106 may advertise its compute capabilities to the handheld device 102, allowing the handheld device 102 to offload the program code for performing the compute operations.

At step 406, the handheld device 102 offloads data to the offload device 106 that is required for performing the compute operations. Upon offloading the data, the processing related to the compute operations occur at the offload device 106. At step 408, the handheld device 102 receives the processed results of the compute operations.

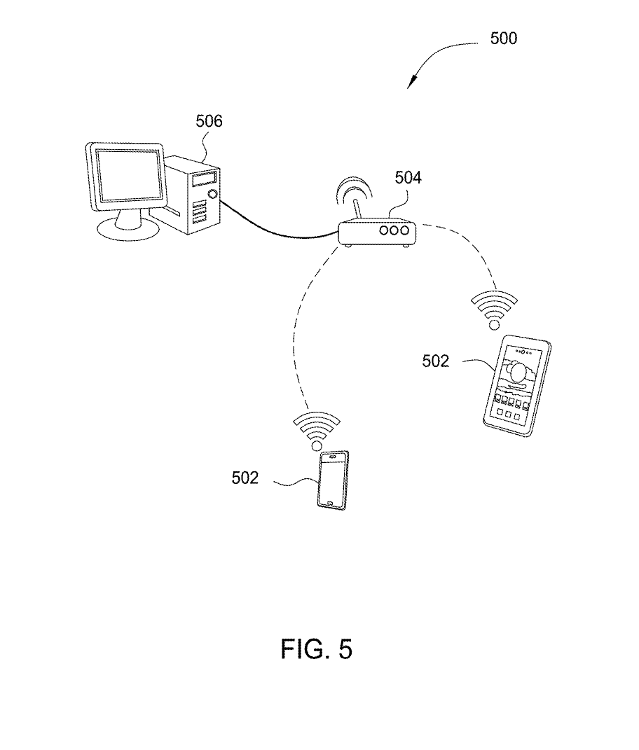

The techniques described above for offloading compute operations to an offload device via one or more low-latency communications protocols may be implemented in more conventional Wi-Fi network topologies too. For example, FIG. 5 provides an illustration of a conventional WPAN 500 configured to implement one or more aspects of the present invention. As shown, the WPAN 500 includes, without limitation, one or more battery-powered handheld devices 502 and an “offload” device 506. Examples of handheld devices 502 generally include, without limitation, cellular phones, smart phones, personal digital assistants, and tablet devices. The offload device 506 has relatively greater computing capabilities than the different handheld devices 502. In various embodiments, for example, the offload device 506 may be, without limitation, a desktop or server machine that has one or more GPUs or one or more GPUs that are configurable to implement CUDA capabilities. In other embodiments, the offload device may be another handheld device that has higher computing capabilities and is plugged into an alternating-current power source and, thus, not power-limited like handheld devices 102. Within the WPAN 500, the different handheld devices 502 and the offload device 506 communicate via an access point 504. In various embodiments, WPAN 500 may include any number of handheld devices 502 and any number of offload devices 506. The WPAN illustrated in FIG. 5 is set up such that access point 504 acts as a central hub to which the handheld devices 502 and the offload device 506 are connected. In other words, the handheld devices 502 and the offload device 506 do not communicate directly, but communicate via the access point 504.

In one embodiment, WPAN 500 is configured such that the handheld devices 502 may offload certain classes of compute operations to the offload device 506 by utilizing the access point 504. Because communications between the handheld devices 502 and device 506 are transmitted through the access point 504, there may be bandwidth limitations or performance issues when offloading those compute operations to the offload device 506. For example, the amount of data offloaded from a handheld device 502 when offloading a particular type of compute operation to the offload device 506 may exceed the bandwidth limitations of the channel between the handheld device 502 and the offload device 506. In such a situation, not all the data necessary to perform the compute operation can be transmitted to the offload device 506. Therefore, the handheld device 502 is configured to reduce the amount of data transmitted to the offload device 506.

In addition to bandwidth limitations, there also may be timing limitations that reduce the efficacy of offloading compute operations within WPAN 500. For example, the amount of time required to offload a compute operation from the handheld device 502 to the offload device 506 and receive the processed results back from the offload device 506 may be increased because those transmissions have to pass through the access point 504. Consequently, the round trip time associated with offloading compute operations from the handheld device 502 to the offload device 506 may exceed the processing time tolerated by the relevant compute application executing on the handheld device 502. In such situations, the offload techniques described herein may result in a poor user experience. Nonetheless, certain compute applications may have processing times that can be met, even when the transmissions related to compute operations offloaded from the handheld device 502 and the offload device 506 have to pass through the access point 504. Examples of such compute applications may include compute operations suited for near-real-time computing offload scenarios, such as batch processing of a large amount of data (e.g., facial recognition on all photos stored on a handheld device 502 or auto-fix of a badly captured video). In other words, the handheld device 502 may offload compute operations to the offload device 506 that do not require real-time processing.

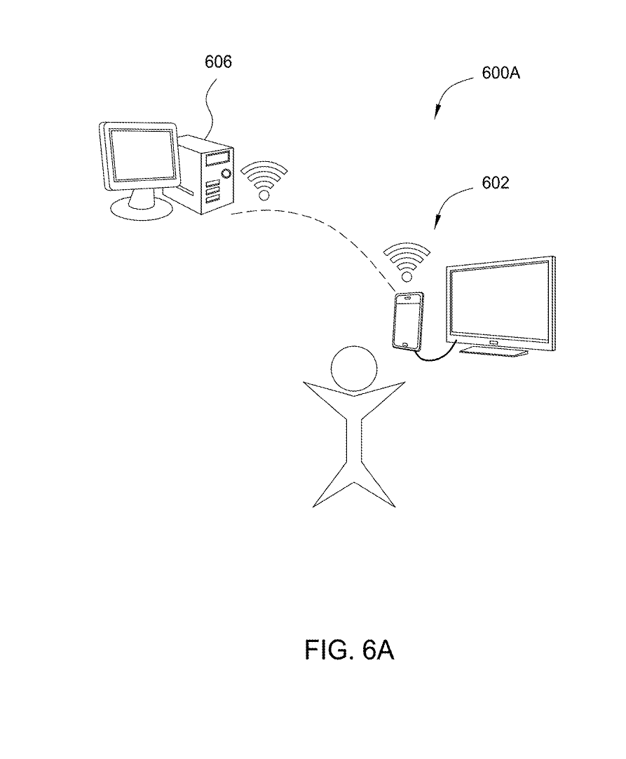

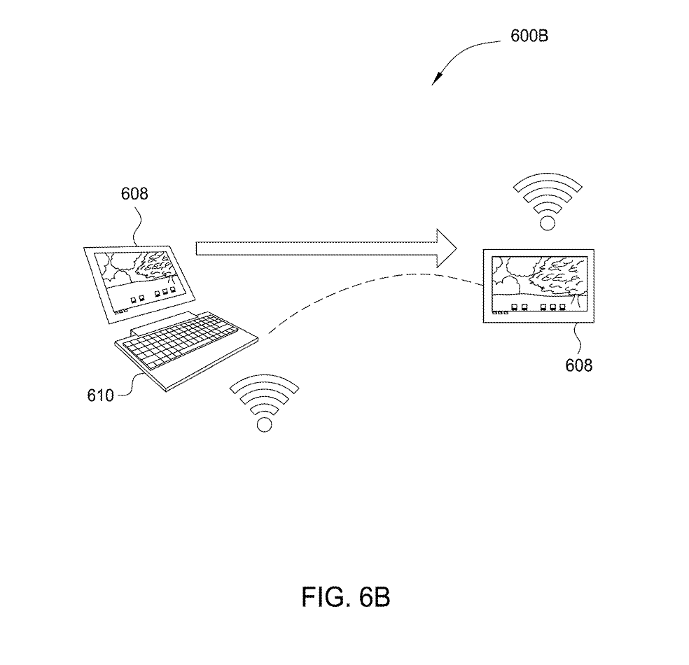

The techniques described above for offloading compute operations to an offload device via one or more low-latency communications protocols allows a handheld device to execute various compute applications. For example, FIG. 6A provides an illustration 600A of a handheld device 602 that is utilized for gesture recognition, according to one embodiment of the present invention. As shown, the illustration 600A includes the handheld device 602 and an offload device 606 in a WPAN. When the handheld device 602 recognizes a gesture, the handheld device 602 may capture a photo or video of the gesture, and transmit the photo or video to the offload device 606 for processing. For some embodiments, in addition to transmitting the photo or video to the offload device 606, the handheld device 602 offloads program code to the offload device 606 that is used for performing the compute operations. The processing related to the gesture recognition task occurs at the offload device 606, and the offload device 606 then transmits the processed results back to the handheld device 602. Since gesture recognition involves the real-time processing of captured photos and videos, it is preferable to use one or more low-latency communications protocols, such as Wi-Fi Direct or a combination of Wi-Fi Direct and RTP, in an effort to reduce latencies.

FIG. 6B provides an illustration 600B for offloading compute operations from a handheld device 608 to an offload device 610, according to one embodiment of the present invention. As shown, the illustration 600B includes a detachable handheld device 608 with a base containing one or more GPUs (i.e., the offload device 610). When a user detaches the handheld device 608 from its base, the handheld device 608 may offload certain classes of compute operations to the base, thereby circumventing the need for the handheld device 608 to perform those compute operations, which would drain the batteries powering the handheld device 608. Examples of the various compute applications that may be executed by the handheld device 608 include, but are not limited to, auto-fix of captured video (e.g., video stabilization), stereoscopic image and video processing, computer vision (e.g., gesture recognition and facial recognition), and computational photography (e.g., panorama stitching).

In sum, embodiments of the invention provide techniques for offloading certain classes of compute operations from battery-powered handheld devices operating in a wireless private area network (WPAN) to devices with relatively greater computing capabilities operating in the WPAN that are not power-limited by batteries. Examples of such “offload” devices that have greater computing capabilities, but are not power-limited include, without limitation, desktop or server machines that have one or more graphics processing units (GPUs) or one or more GPUs that are configurable to implement Compute Unified Device Architecture (CUDA) capabilities. In order to offload certain classes of compute operations, a handheld device (i.e., the client) may discover an offload device within a local network via a discovery mechanism that includes a low-latency data transmission protocol, such as Wi-Fi Direct. Once the offload device is discovered, the handheld device may offload large or complex compute operations to the offload device, thereby circumventing the need for the handheld device to perform those compute operations, which would drain the batteries powering the handheld device.

As an example for offloading certain classes of compute operations from the handheld device to the offload device, the offload device may advertise specific services that the handheld device may need, such as support for gesture recognition or facial recognition tasks. If the handheld device is then utilized for a gesture recognition or facial recognition task, the handheld device may offload data collected by the handheld device, such as one or more captured-images, to the offload device that has advertised those specific services. In other words, the processing related to the gesture recognition or facial recognition task occurs at the offload device, and the offload device then transmits the processed results back to the handheld device.

In another contemplated implementation, rather than advertising specific services that a handheld device may utilize, an offload device may advertise its compute capabilities to the handheld device. The handheld device can then leverage those compute capabilities on an as-needed basis, such as when executing a more sophisticated computer program. For example, in addition to offloading captured images for gesture recognition or facial recognition task from the handheld device to the offload device, the handheld device may also offload the program code for processing the gesture recognition or facial recognition task to the offload device. As a result, the offload device processes the gesture recognition or facial recognition task and then transmits the processed results back to the handheld device.

One advantage of the disclosed techniques is that the techniques allow handheld devices to perform complex operations without substantially impacting battery life. Another advantage is that the handheld device has more flexibility in terms of the types of applications that can be installed or downloaded and executed using the handheld device.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A computer-implemented method for offloading one or more compute operations to an offload device, the method comprising:
discovering the offload device in a wireless private area network (WPAN) via a low-latency communications protocol;
offloading data to the offload device for performing the one or more compute operations; and
receiving from the offload device processed data generated when the one or more compute operations are performed on the offloaded data.

2. The method of claim 1, wherein the low-latency communications protocol comprises Wi-Fi Direct or real-time transport protocol (RTP).

3. The method of claim 1, wherein discovering the offload device comprises receiving an advertisement of one or more specific compute operations that the offload device is capable of performing.

4. The method of claim 3, wherein the one or more specific compute operations comprises the one or more compute operations.

5. The method of claim 4, wherein the offload device performs the one or more compute operations based on the offloaded data and program code installed on the offload device.

6. The method of claim 1, wherein discovering the offload device comprises receiving an advertisement of compute capabilities of the offload device.

7. The method of claim 6, further comprising offloading program code to the offload device to use in performing the one or more compute operations.

8. The method of claim 7, wherein the offload device performs the one or more compute operations based on the offloaded data and the offloaded program code.

9. The method of claim 1, wherein discovering the offload device comprises negotiating a link with the offload device via Wi-Fi Protected Setup.

10. The method of claim 1, wherein the offload device comprises a machine that includes one or more graphics processing units (GPUs) or one or more GPUs that are configurable to implement the Compute Unified Device Architecture (CUDA).

11. A system, comprising:
a handheld device capable of offloading one or more compute operations to an offload device, wherein the handheld device is configured to:
discover the offload device in a wireless private area network (WPAN) via a low-latency communications protocol;
offload data to the offload device for performing the one or more compute operations; and
receive from the offload device processed data generated when the one or more compute operations are performed on the offloaded data.

12. The system of claim 11, wherein the low-latency communications protocol comprises Wi-Fi Direct or real-time transport protocol (RTP).

13. The system of claim 11, wherein the handheld device is configured to discover the offload device by receiving an advertisement of one or more specific compute operations that the offload device is capable of performing.

14. The system of claim 13, wherein the one or more specific compute operations comprises the one or more compute operations.

15. The system of claim 14, further comprising the offload device, wherein the offload device is configured to perform the one or more compute operations based on the offloaded data and program code installed on the offload device.

16. The system of claim 11, wherein the handheld device is configured to discover the offload device by receiving an advertisement of compute capabilities of the offload device.

17. The system of claim 16, wherein the handheld device is further configured to offload program code to the offload device to use in performing the one or more compute operations.

18. The system of claim 17, further comprising the offload device, wherein the offload device is configured to perform the one or more compute operations based on the offloaded data and the offloaded program code.

19. The system of claim 11, wherein the handheld device is configured to discover the offload device by negotiating a link with the offload device via Wi-Fi Protected Setup.

20. The system of claim 11, wherein the offload device comprises a machine that includes one or more graphics processing units (GPUs) or one or more GPUs that are configurable to implement the Compute Unified Device Architecture (CUDA).
